(19) United States
(12) Patent Application Publication
(10) Pub. No.: US 2020/0287478 A1
(43) Pub. Date: Sep. 10, 2020

(54) ACTUATOR

(71) Applicant: JTEKT CORPORATION, Osaka (JP)

(72) Inventor: Takeshi KAWABAYASHI, Kashiba-shi (JP)

(73) Assignee: JTEKT CORPORATION, Osaka (JP)

(21) Appl. No.: 16/803,273

(22) Filed: Feb. 27, 2020

(30) Foreign Application Priority Data
Mar. 4, 2019 (JP) 2019-038170

(51) Int. Cl. H02N 1/00

(52) U.S. Cl. CPC H02N 1/006

(57) ABSTRACT

An actuator is configured such that a first film body and a second film body are stacked on each other. The first film body includes a first dielectric elastomer film and a first electrode layer provided on a surface of the first dielectric elastomer film. The second film body includes a second dielectric elastomer film and a second electrode layer provided on a surface of the second dielectric elastomer film. The electrode layer included in at least one of the first film body and the second film body includes a plurality of linear electrodes extending in a first direction and provided at intervals in a second direction that is orthogonal to the first direction.

### CROSS-REFERENCE TO RELATED APPLICATION

This application claims priority to Japanese Patent Application No. 2019-038170 filed on Mar. 4, 2019, incorporated herein by reference in its entirety

### BACKGROUND

### 1. Technical Field

The present disclosure relates to an actuator.

### 2. Description of Related Art

An actuator using dielectric elastomers is known as one of conversion devices that are operated by converting an electrical energy into a mechanical energy. This actuator includes a dielectric elastomer film and a pair of electrode layers. The electrode layers are provided on respective sides of the dielectric elastomer film. When a voltage is applied between the electrode layers, the electrode layers attract each other by the Coulomb's force generated between the electrode layers. The dielectric elastomer film interposed between the electrode layers is elastically deformed so as to be compressed in a thickness direction of the film, and accordingly, elastically deformed and extend in a direction along the film surface (in a surface direction).

As the number of layers of dielectric elastomer film increases, a potential capacitance increases, and an output from the actuator also increases. In order to increase the number of layers of the film, a plurality of film bodies each having the dielectric elastomer film and the electrode layers are stacked as described in, for example, Japanese Unexamined Patent Application Publication No. 2011-103713 (JP 2011-103717 A). Alternatively, as described in the Japanese Unexamined Patent Application Publication No. 2018-93467 (JP 2018-93467 A), a dielectric elastomer film has an electrode layer printed on its entire surface, and two of those dielectric elastomer films are stacked on each other and rolled together. With the configurations described above, the actuator has a configuration in which the dielectric elastomer films are stacked on each other.

### SUMMARY

According to the disclosure disclosed in JP 2018-93467 A, a configuration in which the plurality of layers of dielectric elastomer film are provided can be easily obtained. However, for example, when an actuator is configured to extend and be compressed in a direction of a central axis of the rolled films, a displacement amount (extension amount) is reduced as described below. That is, in the disclosure of JP 2018-93467 A, the electrode layer is provided in a planar shape in the dielectric elastomer film. With this configuration, when the film body having the dielectric elastomer film and the electrode layer is rolled, the direction in which the Coulomb's force acts is dispersed. That is, the rolled dielectric elastomer film extends in all surface directions (in all directions along the surface). This makes it difficult to obtain a desired large displacement amount with respect to the direction of the central axis of the rolled films, and thus the displacement amount becomes small.

In the case of the disclosures disclosed in JP 2011-103713 A and JP 2018-93467 A, the dielectric elastomer film and the electrode layer are in close contact with each other in the entire area. With this configuration, the dielectric elastomer film is hindered from being deformed by the electrode layer even if the dielectric elastomer film tries to deform in the surface direction when the voltage is applied, although the electrode layer is elastically deformable.

Consequently, with the actuator described above, it is difficult to obtain a large displacement amount. Therefore, the present disclosure provides an actuator that includes the dielectric elastomer film and the electrode layer and that can have a large displacement amount.

An actuator according to an aspect of the present disclosure includes a first film body having a first dielectric elastomer film and a first electrode layer provided on a surface of the first dielectric elastomer film; and a second film body having a second dielectric elastomer film and a second electrode layer provided on a surface of the second dielectric elastomer film. The actuator is configured such that the first film body and the second film body are stacked on each other. The electrode layer included in at least one of the first film body and the second film body includes a plurality of linear electrodes extending in a first direction and provided at intervals in a second direction that is orthogonal to the first direction.

According to the actuator above, when the first film body and the second film body are repeatedly stacked on each other, each of the first dielectric elastomer film and the second dielectric elastomer film is interposed between the first electrode layer and the second electrode layer. When a voltage is applied to the first electrode layer and the second electrode layer, each of the first and second dielectric elastomer films extends in a direction (surface direction) along a surface of the film. The electrode layer of the actuator according to the present disclosure has the plurality of linear electrodes extending in the first direction, and the linear electrodes are provided at intervals in the second direction. Therefore, in the electrode layer, the action of hindering extension of the dielectric elastomer film in the second direction is alleviated. Accordingly, the dielectric elastomer film is able to easily extend in the second direction, and a displacement amount (extension amount) in the second direction thus increases. With the configuration above, the actuator having a large displacement amount (extension amount) can be obtained.

In the above aspect, the first film body and the second film body may be rolled while the first film body and the second film body are stacked on each other. With this configuration, the actuator having a cylindrical shape and having a configuration in which the first film body and the second film body are repeatedly stacked on each other can be easily fabricated. Furthermore, the first film body and the second film body may be rolled such that the first direction coincides with a direction in which the first film body and the second film body are rolled while the first film body and the second film body are stacked on each other. With this configuration, the second direction serves as an axial direction of the cylindrical shape. The actuator that is able to have a large displacement amount (extension amount) in the axial direction can be obtained.

In the above aspect, the electrode layer may include the plurality of linear electrodes extending in the first direction, a first connection electrode connecting a first end of one of the linear electrodes and a first end of another one of the linear electrodes that is adjacent to the one of the linear electrodes on one side, a second connection electrode connecting a second end of the one of the linear electrodes and a second end of yet another one of the linear electrodes that is adjacent to the one of the linear electrodes on the other side. With this configuration, the linear electrodes are widely disposed in a zigzag arrangement on the dielectric elastomer film. A configuration can be obtained in which the linear electrodes provided at intervals in the second direction are electrically connected in series. Therefore, an electric charge generated in the dielectric elastomer film along a longitudinal direction of the linear electrodes becomes uniform, and the Coulomb's force that is entirely uniform is generated. Therefore, the actuator can be deformed in the second direction with a uniform and impartial deformation amount.

According to the present disclosure, the actuator having a large displacement amount (extension amount) can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing an embodiment of an actuator;

FIG. 2 is a perspective view showing the actuator in operation;

FIG. 3 is an illustrative view showing a state in which the actuator having a rolled shape is unrolled to be a planar state;

FIG. 4 is an illustrative view showing a manufacturing method of the actuator having a rolled shape;

FIG. 5 is a sectional view showing a part of the actuator having a cylindrical shape;

FIG. 6 is a view illustrating a function of the actuator;

FIG. 7 is a view illustrating a modification example of the actuator;

FIG. 8 is a view illustrating a modification example of the actuator;

FIG. 9 is a view illustrating a function of the actuator shown in FIG. 8;

FIG. 10 is a perspective view showing an actuator according to another embodiment; and

FIG. 11 is an illustrative view showing a modification example of a first electrode layer included in a first film body.

### DETAILED DESCRIPTION OF EMBODIMENTS

Outline of Actuator

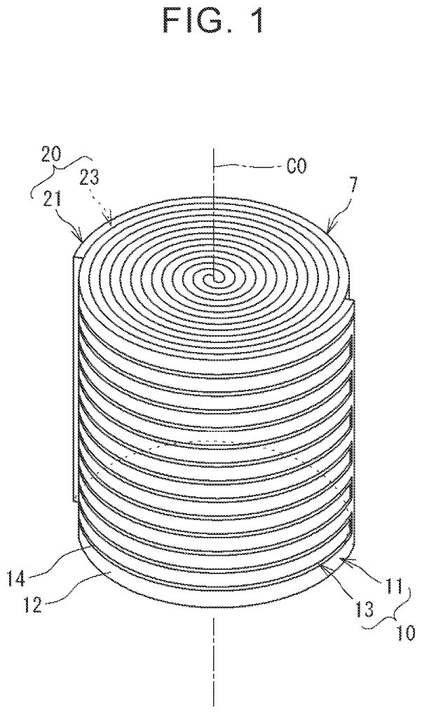

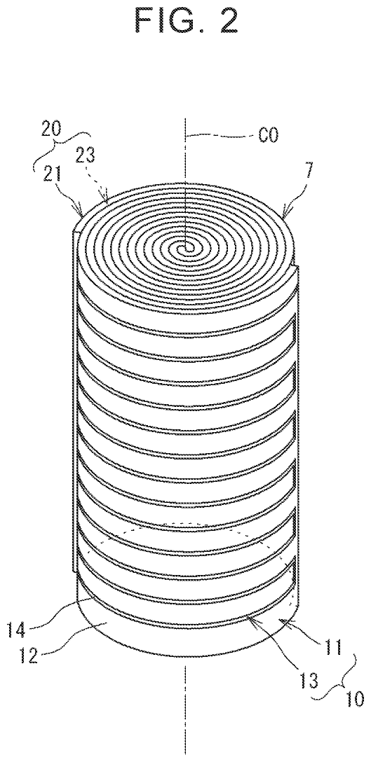

FIG. 1 is a perspective view showing an embodiment of an actuator. An actuator 7 shown in FIG. 1 is one of conversion devices that are operated by converting an electric energy into a mechanical energy. The detailed configuration and operations of the actuator 7 are described later. The actuator 7 includes dielectric elastomer films 11, 21 and a pair of electrode layers 13, 23. When a voltage is applied to the electrode layers 13, 23 with one of the electrode layers 13, 23 set as positive and the other set as negative, the actuator 7 is deformed as shown in FIG. 2.

The actuator 7 shown in FIG. 1 has a cylindrical shape in which the dielectric elastomer films 11, 21 are rolled. The dielectric elastomer films 11, 21 include the electrode layers 13, 23, on the surfaces of the dielectric elastomer films 11, 21, respectively. When a voltage is applied to the electrode layers 13, 23, the actuator 7 is elastically deformed from the initial state and extends in a direction along a central axis C0 of the cylindrical shape of the rolled films. When application of the voltage to the electrode layers 13, 23 is stopped, the actuator 7 regains its initial state as shown in FIG. 1 by an elastic restoring force. In FIG. 2, the deformation amount is shown larger than the actual deformation amount to make description understandable.

Specific Configuration of Actuator 7

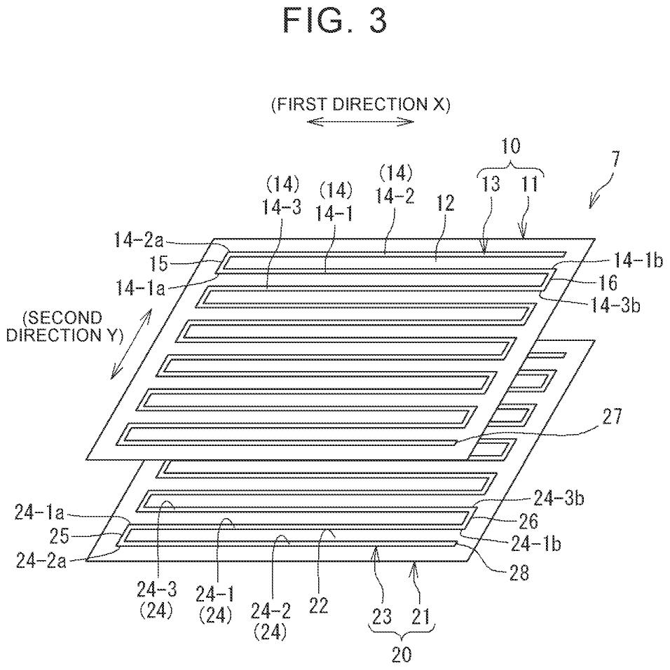

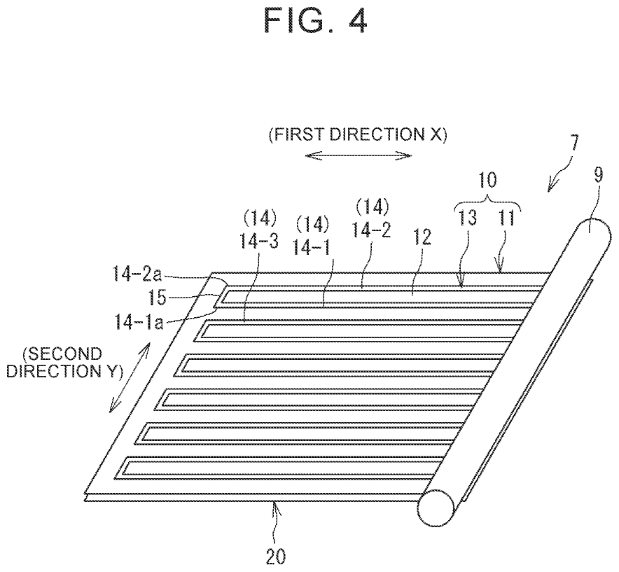

FIG. 3 is an illustrative diagram showing a state in which the actuator 7 having a rolled shape as shown in FIG. 1 is unrolled to be a planar state. The actuator 7 includes a first film body 10 and a second film body 20. The actuator 7 is configured by stacking the first film body 10 and the second film body 20 on each other and rolling the stacked first film body 10 and the second film body 20. As shown in FIG. 4, the actuator 7 is configured by stacking the first film body 10 and the second film body 20 on each other and rolling the stacked first film body 10 and the second film body 20 around, for example, a core 9 that has an elongated cylindrical shape. After the first film body 10 and the second film body 20 are rolled, the core 9 is taken out of the rolled film bodies.

As shown in FIG. 3, the first film body 10 includes a first dielectric elastomer film 11 and a first electrode layer 13 provided on a surface 12 of the first dielectric elastomer film 11. The second film body 20 includes the second dielectric elastomer film 21 and the second electrode layer 23 provided on the surface 22 of the second dielectric elastomer film 21. The first dielectric elastomer film 11 is a different member (dielectric film) from the second dielectric elastomer film 21. The first electrode layer 13 is a different electrode (member) from the second electrode layer 23. The first electrode layer 13 and the second electrode layer 23 are electrodes having electrically different (positive and negative) signs.

As shown in FIG. 3, the first dielectric elastomer film 11 includes a plurality of linear electrodes 14, and first connection electrodes 15 and second connection electrodes 16 on the surface 12 of the first dielectric elastomer film 11. The first connection electrode 15 and the second connection electrode 16 connect between the ends of the linear electrodes 14 that are adjacent to each other. Each of the linear electrodes 14 extends linearly along a first direction X. The linear electrodes 14 are provided at intervals in a second direction Y. The first direction X is orthogonal to the second direction Y. The reference numeral for one of the linear electrodes 14 is denoted as “14-1” in the first film body 10 shown in FIG. 3. The reference numeral for another one of the linear electrodes 14 that is adjacent to the linear electrode 14-1 on one side in the second direction Y is denoted as “14-2”. The reference numeral for yet another one of the linear electrodes 14 that is adjacent to the linear electrode 14-1 on the other side in the second direction Y is denoted as “14-3”. The first connection electrode 15 connects a first end 14-1a of the linear electrode 14-1 in the first direction X and a first end 14-2a of the linear electrode 14-2 in the first direction X. The second connection electrode 16 connects a second end 14-1b of the linear electrode 14-1 in the first direction X and a second end 14-3b of the linear electrode 14-3 in the first direction X.

A configuration is thus obtained in which electrodes (wiring pattern) are disposed in a zigzag arrangement consisting of the linear electrodes 14, the first connection electrodes 15, and the second connection electrodes 16. The first electrode layer 13 consists of the linear electrodes 14, the first connection electrodes 15, and the second connection electrodes 16. The linear electrodes 14, the first connection electrodes 15, and the second connection electrodes 16 are provided on the surface 12 of the dielectric elastomer film 11 by printing or coating. That is, the electrode layer 13 is fixed to the dielectric elastomer film 11.

The second electrode layer 23 of the second film body 20 has the same configuration as that of the first electrode layer 13. That is, the second dielectric elastomer film 21 includes a plurality of linear electrodes 24, and first connection electrodes 25 and second connection electrodes 26 on the surface 22 of the second dielectric elastomer film 21. The first connection electrode 25 and the second connection electrode 26 connect the respective ends of the linear electrodes 24 that are adjacent to each other. Each of the linear electrodes 24 extends linearly along the first direction X. The linear electrodes 24 are provided at intervals in the second direction Y. The reference numeral for one of the linear electrodes 24 is denoted as “24-1” in the second film body 20 shown in FIG. 3. The reference numeral for another one of the linear electrodes 24 that is adjacent to the linear electrode 24-1 on the one side in the second direction Y is denoted as “24-2”. The reference numeral for yet another one of the linear electrodes 24 that is adjacent to the linear electrode 24-1 on the other side in the second direction Y is denoted as “24-3”. The first connection electrode 25 connects a first end 24-1a of the linear electrode 24-1 in the first direction X and a first end 24-2a of the linear electrode 24-2 in the first direction X. The second connection electrode 26 connects a second end 24-1b of the linear electrode 24-1 in the first direction X and a second end 24-3b of the linear electrode 24-3 in the first direction X.

A configuration is thus obtained in which the electrodes (wiring pattern) are disposed in a zigzag arrangement consisting of the linear electrodes 24, the first connection electrodes 25, and the second connection electrodes 26. The second electrode layer 23 consists of the linear electrodes 24, the first connection electrodes 25, and the second connection electrodes 26. The linear electrodes 24, the first connection electrodes 25, and the second connection electrodes 26 are provided on the surface 22 of the second dielectric elastomer film 21 by printing or coating. That is, the electrode layer 23 is fixed to the second dielectric elastomer film 21.

Each of the first dielectric elastomer film 11 and the second dielectric elastomer film 21 consists of a rectangular sheet. The first and second dielectric elastomer films 11, 21 are made of rubber, such as silicon rubber, acrylic rubber, urethane rubber, and nitrile rubber (NBR). Each of the first electrode layer 13 and the second electrode layer 23 is made of an elastic material having conductivity. For example, the electrode layers 13, 23 are made of conductive silicon rubber and conductive gel. A conductive material (conductive filler), such as carbon black, is added to the elastic material such that the electrode layers 13, 23 have conductivity.

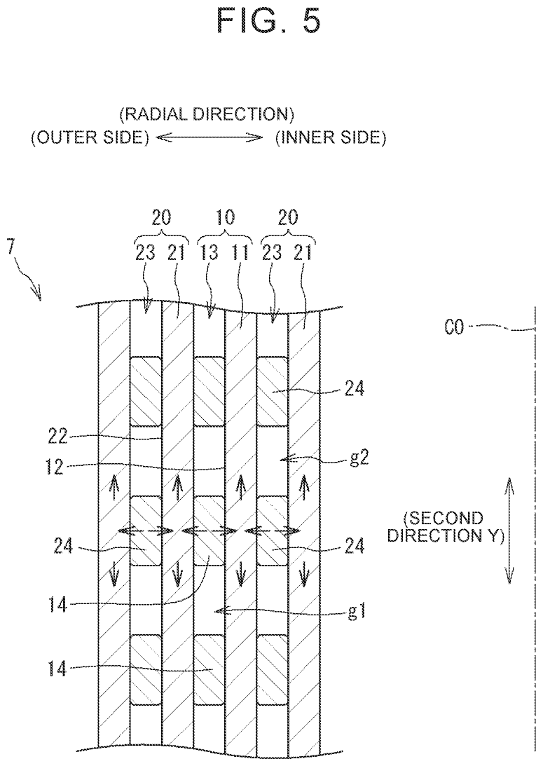

As described above (see FIGS. 1 and 4), the first film body 10 and the second film body 20 are stacked on each other and rolled in a stacked state such that the first film body 10 and the second film body 20 are alternately arranged and the actuator 7 has a cylindrical shape. FIG. 5 is a sectional view showing a part of the actuator 7 having a cylindrical shape. FIG. 5 shows a part of a section including the central axis C0 (see FIG. 1) of the actuator 7 having a cylindrical shape. The right side in FIG. 5 is closer to the central axis C0, and referred to as a radially inner side. The left side in FIG. 5 is a side opposite to the central axis C0, and referred to as a radially outer side.

The first film body 10 is stacked on the second film body 20 on the radially outer side (on the right side in FIG. 5) such that the first electrode layer 13 is positioned along a surface (the surface 12) of the first dielectric elastomer film 11 on the radially outer side, and the second electrode layer 23 is positioned along a surface of the first dielectric elastomer film 11 on the radially inner side. That is, the first dielectric elastomer film 11 is interposed between the first electrode layer 13 and the second electrode layer 23. The second film body 20 is stacked on the first film body 10 on the radially outer side such that the second electrode layer 23 is positioned along a surface (the surface 22) of the second dielectric elastomer film 21 on the radially outer side, and the first electrode layer 13 is positioned along a surface of the second dielectric elastomer film 21 on the radially inner side. That is, the second dielectric elastomer film 21 is interposed between the first electrode layer 13 and the second electrode layer 23.

As described above (see FIGS. 3 and 4), the first linear electrodes 14 are provided at intervals in the second direction Y. Therefore, in FIG. 5, a gap (space) g1 is provided between the first linear electrodes 14 that are adjacent to each other in the second direction Y. The gap g1 is continuous in a circumferential direction (in the first direction X). Similarly, the second linear electrodes 24 are provided at intervals in the second direction Y. Therefore, a gap (space) g2 is provided between the second linear electrodes 24 that are adjacent to each other in the second direction Y. The gap g2 is continuous in the circumferential direction (in the first direction X).

A voltage is applied to the first electrode layer 13 and the second electrode layer 23. Application of the voltage will be described with reference to FIG. 3 that shows a state in which the actuator 7 is unrolled. The voltage is applied to the first electrode layer 13 and the second electrode layer 23 with an end 27 of the linear electrode 14 that is a part of the first electrode layer 13 and an end 28 of the linear electrode 24 that is a part of the second electrode layer 23 serve as terminals. For example, the end 27 of the first electrode layer 13 serves as a positive terminal, and the end 28 of the second electrode layer 23 serves as a negative terminal.

When the voltage is applied to the first electrode layer 13 and the second electrode layer 23, the electrode layers 13, 23 attract each other by the Coulomb's force generated between the electrode layers 13, 23. The first dielectric elastomer film 11 interposed between the electrode layers 13, 23, as shown in FIG. 5, is elastically deformed to be compressed in a film thickness direction, that is, in a radial direction. Similarly, the second dielectric elastomer film 21 interposed between the electrode layers 13, 23 is elastically deformed to be compressed in the film thickness direction, that is, in the radial direction. Accordingly, the entire actuator 7 becomes thin (smaller in the radial direction) as shown in FIG. 2.

On the other hand, when the voltage is applied, each of the first and the second dielectric elastomer films 11, 21 extends in a direction along the surfaces of the films (in the surface direction), as shown in FIG. 5. Each of the dielectric elastomer films 11, 21 extends in a direction orthogonal to the paper surface in FIG. 5, in other words, in the circumferential direction about the central axis C, and also extends in a direction parallel to the central axis C that is along a vertical direction in FIG. 5. The direction parallel to the central axis C is coincident with the second direction Y. The linear electrodes 14, 24 are elongated along the circumferential direction about the central axis C. Therefore, extension of the first and second dielectric elastomer films 11, 21 in the circumferential direction is partially hindered by the linear electrodes 14, 24. On the other hand, the linear electrodes 14, 24 are provided at intervals in the direction parallel to the central axis C (the second direction Y). Therefore, extension of the first and the second dielectric elastomer films 11, 21 in the direction parallel to the central axis C is not hindered by the linear electrodes 14, 24. Therefore, the actuator 7 extends to a greater extent in the direction parallel to the central axis C, in other words, in the second direction Y.

As described above, the actuator 7 of the present disclosure is configured such that the first film body 10 and the second film body 20 are stacked on each other. The first film body 10 includes the first dielectric elastomer film 11 and the first electrode layer 13 provided on the surface 12 of the first dielectric elastomer film 11. The second film body 20 includes the second dielectric elastomer film 21 and the second electrode layer 23 provided on the surface 22 of the second dielectric elastomer film 21. As shown in FIG. 3, the first electrode layer 13 includes the plurality of linear electrodes 14 extending in the first direction X and provided at intervals in the second direction Y. The second electrode layer 23 includes the plurality of linear electrodes 24 extending in the first direction X and provided at intervals in the second direction Y.

In the actuator 7, as shown in FIG. 5, the first film body 10 and the second film body 20 are stacked on each other, and each of the first dielectric elastomer film 11 and the second dielectric elastomer film 21 is interposed between the first electrode layer 13 and the second electrode layer 23. When the voltage is applied to the first electrode layer 13 and the second electrode layer 23, the electrode layers 13, 23 attract each other by the Coulomb's force generated between the electrode layers 13, 23. Then, the first dielectric elastomer film 11 interposed between the electrode layers 13, 23 and the second dielectric elastomer film 21 interposed between the electrode layers 13, 23 are each elastically deformed such that the first dielectric elastomer film 11 and the second dielectric elastomer film 21 are compressed in the film thickness direction. This extends each of the first dielectric elastomer film 11 and the second dielectric elastomer film 21 in the direction along the surfaces of the films (in the surface direction).

In the first film body 10, the first electrode layer 13 is provided (fixed) on the surface 12 of the first dielectric elastomer film 11. With this configuration, the first dielectric elastomer film 11 is hindered from being deformed by the first electrode layer 13 even if the first dielectric elastomer film 11 tries to extend in the surface direction, although the first electrode layer 13 is elastically deformable. However, the first electrode layer 13 included in the actuator 7 of the present disclosure has the plurality of linear electrodes 14 extending in the first direction X, and the linear electrodes 14 are provided at intervals in the second direction Y as described above. Accordingly, the action of the first electrode layer 13 to hinder the extension of the first dielectric elastomer film 11 in the second direction Y is alleviated. Therefore, the first dielectric elastomer film 11 has a large displacement amount (extension amount) in the second direction Y.

The second film body 20 also has the function to alleviate the action of hindering the extension in the second direction Y as described above. That is, the second electrode layer 23 has the plurality of linear electrodes 24 extending in the first direction X, and the linear electrodes 24 are provided at intervals in the second direction Y as described above. Therefore, the second dielectric elastomer film 21 has a large displacement amount (extension amount) in the second direction. Consequently, the actuator 7 having a large displacement amount (extension amount) can be obtained.

Here, in general, as the number of layers of the dielectric elastomer film increases, the potential capacitance increases, and the output of the actuator increases. In the present disclosure, to increase the number of layers, the first film body 10 and the second film body 20 are rolled while the first film body 10 and the second film body 20 are stacked on each ether. With this configuration, the actuator 7 having a cylindrical shape and having a configuration in which the first film body 10 and the second film body 20 are repeatedly stacked on each other can be easily fabricated. In particular, as shown in FIG. 4, the first film body 10 and the second film body 20 are rolled in the stacked state such that the direction in which the first film body 10 and the second film body 20 are rolled coincides with the first direction X. The second direction Y thus coincides with an axial direction along the central axis C0. Accordingly, the actuator 7 can have a large displacement amount (extent amount) in the axial direction as the output from the actuator 7.

As described above, the first electrode layer 13 includes the plurality of linear electrodes 14 extending in the first direction, the first connection electrode 15 connecting the first ends of the linear electrode 14-1 and the linear electrode 14-2 that are adjacent to each other in the second direction Y, and the second connection electrode 16 connecting the second ends of the linear electrode 14-1 and the linear electrode 14-3 that are adjacent to each other in the second direction Y. Similar to the first electrode layer 13, the second electrode layer 23 includes the plurality of linear electrodes 24 extending in the first direction, the first connection electrode 25 connecting the first ends of the linear electrodes 24-1 and the linear electrode 24-2 that are adjacent to each other in the second direction Y, and the second connection electrode 26 connecting the second ends of the linear electrode 24-1 and the linear electrode 24-3 that are adjacent to each other in the second direction Y.

Therefore, as shown in FIG. 3, in the first dielectric elastomer film 11, the linear electrodes 14 are widely disposed in a zigzag arrangement. Then, a configuration is obtained in which the linear electrodes 14 provided at intervals in the second direction Y are electrically connected in series. Accordingly, an electric charge generated in the first dielectric elastomer film 11 along a longitudinal direction of the linear electrode 14 is uniform. Similar to the first dielectric elastomer film 11, the linear electrodes 24 are widely disposed in a zigzag arrangement in the second dielectric elastomer film 21. A configuration is obtained in which the linear electrodes 24 provided at intervals in the second direction Y are electrically connected in series. Accordingly, an electric charge generated in the first dielectric elastomer film 11 along a longitudinal direction of the linear electrode 24 is uniform. From the above, the Coulomb's force that is entirely uniform is generated in each of the first film body 10 and the second film body 20. Therefore, the actuator 7 can be deformed in the second direction Y with a uniform and impartial deformation amount.

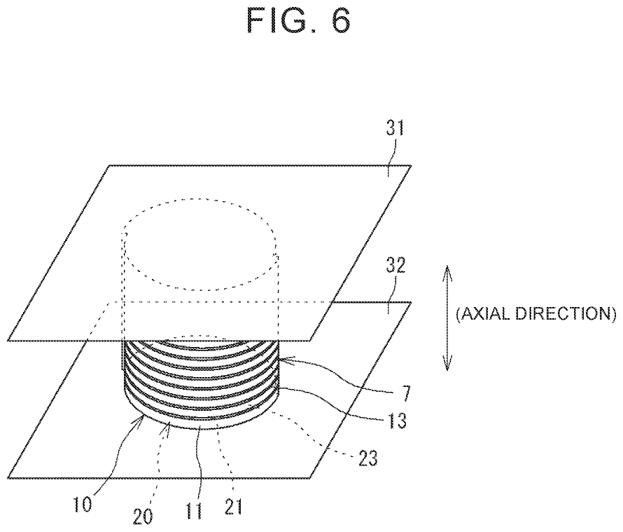

FIG. 6 is a diagram that describes a function of the actuator 7 including the configuration described above. Support surfaces 31, 32 are provided on respective axial sides of the actuator 7 having the configuration in which the film bodies are rolled. The support surfaces 31, 32 are the surfaces of a first member and a second member, respectively, between which the actuator 7 is interposed. When the voltage is applied to the electrode layers 13, 23, the actuator 7 extends in the axial direction. Accordingly, the first member (the support surface 31) and the second member (the support surface 32) become relatively distant away from each other in the axial direction. When application of the voltage is stopped, the extended actuator 7 is compressed in the axial direction by the elastic restoring force and regains its initial state.

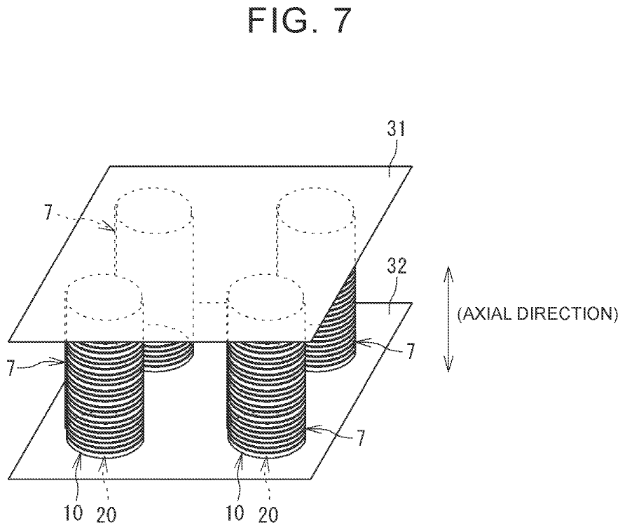

As shown in FIG. 7, a plurality of the actuators 7 may be interposed between the support surfaces 31, 32. The central axes C0 of the respective actuators 7 are parallel to each other. With this configuration, the actuators 7 having a large thrust force can be obtained.

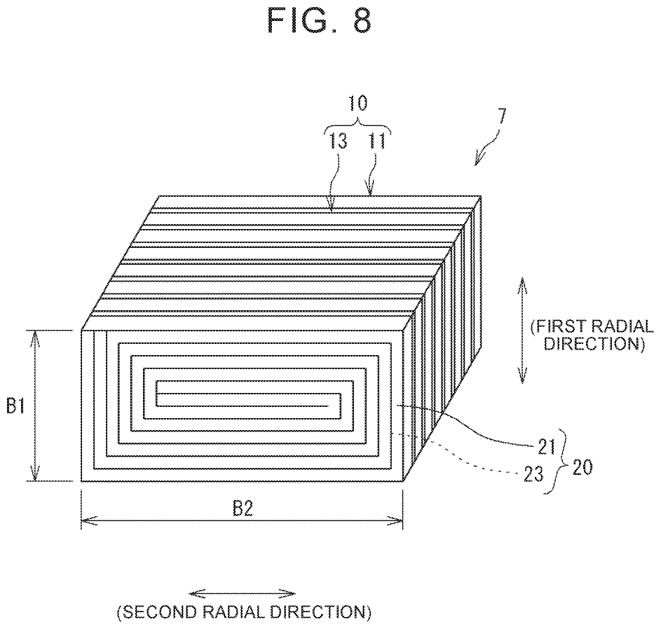

As shown in FIG. 2, the actuator 7 extends in the axial direction and is compressed in the radial direction. Therefore, as shown in FIG. 8, the actuator 7 having the configuration in which the film bodies are rolled may be flattened. That is, the actuator 7 shown in FIG. 8 has a flattened shape in which a dimension B2 in a second radial direction that is orthogonal to a first radial direction is larger than a dimension B131 in the first radial direction.

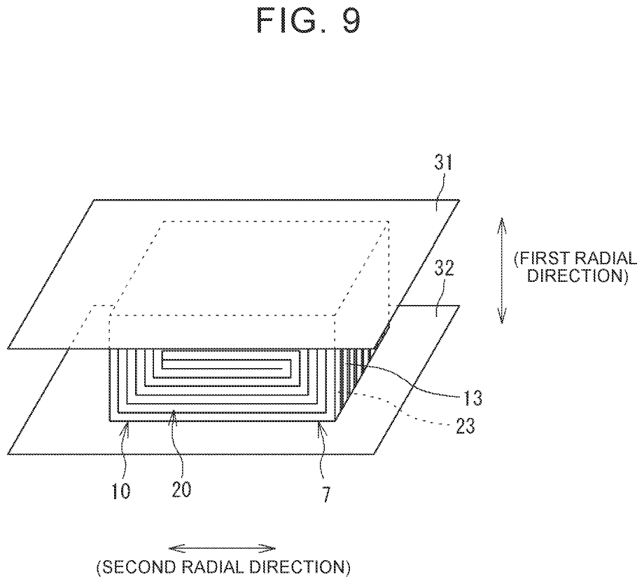

With this configuration, as shown in FIG. 9, the support surfaces 31, 32 are provided on the respective sides of, in the first radial direction, the actuator 7 having the configuration in which the film bodies are rolled as shown in FIG. 8. The actuator 7 is compressed in the first radial direction when the voltage is applied to the electrode layers 13, 23. Consequently, the first member (the support surface 31) and the second member (the support surface 32) relatively approach with each other in the axial direction. When application of the voltage is stopped, the compressed actuator 7 extends by the elastic restoring force and regains its initial state. This widens a gap between the first member (the support surface 31) and the second member (the support surface 32). The support surfaces 31, 32 may be provided on the respective sides of the actuator 7 in the second radial direction, which is a different configuration from that shown in FIG. 9.

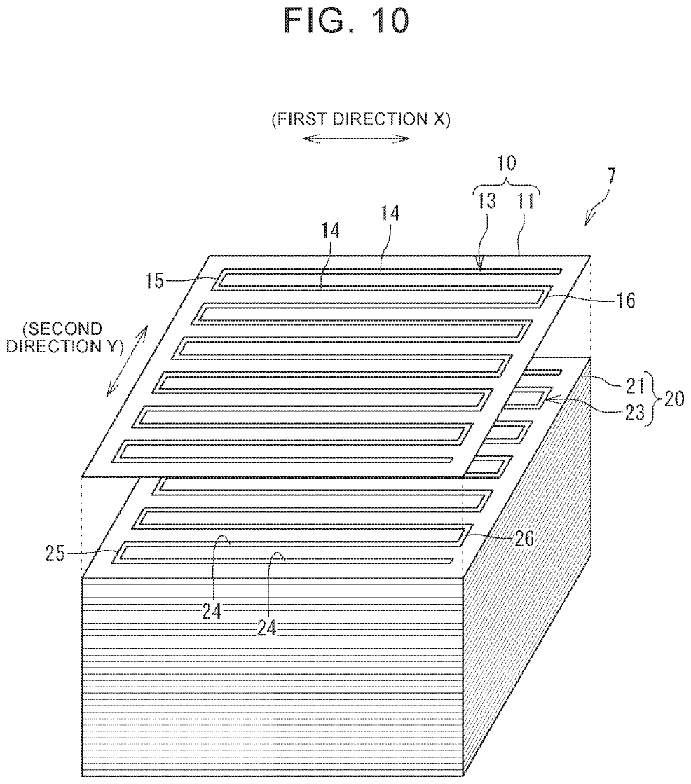

FIG. 10 is a perspective view showing another embodiment of the actuator 7. FIG. 10 shows an exploded view of a part of the actuator 7 (the first film body 10). The actuator 7 shown in FIG. 10 includes the first film body 10 and the second film body 20. This configuration is the same as those of the embodiments described above. The actuators 7 in the above embodiments (see FIG. 1, for example) are configured by rolling the film bodies. In contrast, the actuator 7 shown in FIG. 10 includes a plurality of the first film bodies 10, each of which has a sheet shape, and a plurality of the second film bodies 20, each of which has a sheet shape. In the actuator 7, the first film bodies 10 and the second film bodies 20 are alternately stacked on each other. The first direction X in the first film body 10 is the same direction as the first direction X in the second film body 20.

The first electrode layer 13 included in the first film body 10 includes the plurality of linear electrodes 14 extending in the first direction X and provided at intervals in the second direction Y. The second electrode layer 23 included in the second film body 20 includes the plurality of linear electrodes 24 extending in the first direction X and provided at intervals in the second direction Y. The configuration of each portion in each of the first film body 10 and the second film body 20 is the same as the configuration of each portion described in the above embodiments as shown in, for example, FIG. 3. Therefore, the description thereof will be omitted.

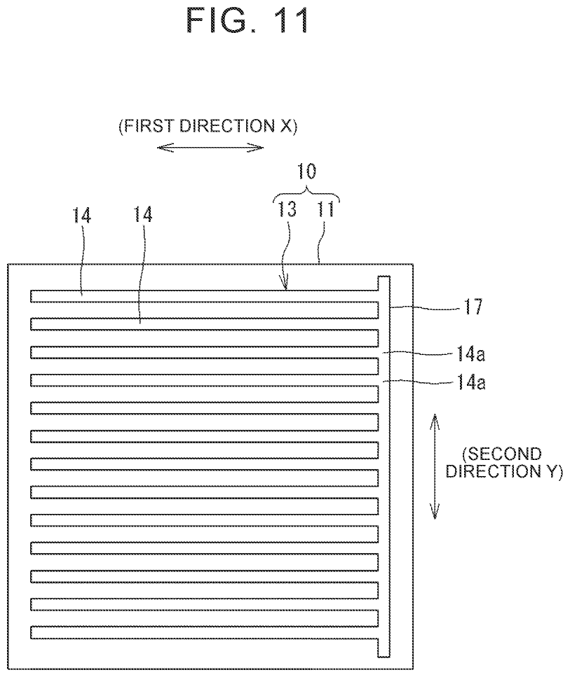

FIG. 11 is an illustrative view showing a modification example of the first electrode layer 13 included in the first film body 10. In each of the above embodiments, as shown in FIG. 3 for example, the first electrode layer 13 has a configuration in which the electrodes are disposed in a zigzag arrangement. On the other hand, the first electrode layer 13 shown in FIG. 11 includes the plurality of the linear electrodes 14 extending in the first direction X and provided at intervals in the second direction Y, and connection electrodes 17 connecting ends 14a of the linear electrodes 14 in the longitudinal direction. The first electrode layer 13 has a configuration in which the electrodes are disposed in a pectinate arrangement consisting of the linear electrodes 14 and the connection electrodes 17. With this configuration, even if wire disconnection occurs in one of the linear electrodes 14, the function of the actuator 7 is not impaired. Although not shown, the second film body 20 also has the same configuration (pectinate arrangement of electrodes) as that of the first film body 10 shown in FIG. 11.

In each of the above embodiments, both the first electrode layer 13 of the first film body 10 and the second electrode layer 23 of the second film body 20 include the plurality of linear electrodes (14, 24) extending in the first direction X and provided at intervals in the second direction Y. However, the electrode layer having the configuration including the linear electrodes described above may be an electrode layer included in at least one of the first film body 10 and the second film body 20. That is, in one of the film bodies, the electrode layer may be provided in a planar shape on the entire dielectric elastomer film.

As described above, the actuator 7 of the present disclosure can have a large displacement amount (extension amount).

The embodiments disclosed herein are illustrative but not restrictive in all respects. The scope of the disclosure is not limited to the embodiments described above, and includes any and all modifications within the scope equivalent to the configuration described in the claims.

What is claimed is:

1. An actuator comprising:
a first film body including a first dielectric elastomer film and a first electrode layer provided on a surface of the first dielectric elastomer film; and
a second film body including a second dielectric elastomer film and a second electrode layer provided on a surface of the second dielectric elastomer film, wherein:
the actuator is configured such that the first film body and the second film body are stacked on each other; and
the electrode layer included in at least one of the first film body and the second film body includes a plurality of linear electrodes extending in a first direction and provided at intervals in a second direction that is orthogonal to the first direction.

2. The actuator according to claim 1, wherein the first film body and the second film body are rolled while the first film body and the second film body are stacked on each other.

3. The actuator according to claim 2, wherein the first film body and the second film body are rolled such that the first direction coincides with a direction in which the first film body and the second film body are rolled while the first film body and the second film body are stacked on each other.

4. The actuator according to claim 1, wherein the electrode layer includes the plurality of linear electrodes extending in the first direction, a first connection electrode connecting a first end of one of the linear electrodes and a first end of another one of the linear electrodes that is adjacent to the one of the linear electrodes on one side, and a second connection electrode connecting a second end of the one of the linear electrodes and a second end of yet another one of the linear electrodes that is adjacent to the one of the linear electrodes on the other side.
